(19) United States
(12) Patent Application Publication
(10) Pub. No.: US 2004/0238691 A1
(43) Pub. Date: Dec. 2, 2004

(54) Compressor for use in aircraft fuel tank air purge system

(76) Inventor: Harold Hipsky, Willington, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/446,598

(22) Filed: May 28, 2003

(51) Int. Cl. B64D 37/00

(52) U.S. Cl. 244/135 R

(57) ABSTRACT

A compressor for use in an airplane fuel tank air purge system utilizes a low solidity diffuser. A low solidity diffuser is useful for providing air to an air separation module associated with the air purge system. In particular, a diffuser for such a compressor must be able to provide increased pressure ratios over a relatively great range of flow volumes. The low solidity diffuser of this invention is capable of providing increased pressure ratios over a relatively great range of flow volumes when compared to the prior art.

### BACKGROUND OF THE INVENTION

The present invention relates to a compressor for providing compressed air to an air separation module associated with a fuel tank air purge system in an aircraft. The compressor is provided with a low solidity diffuser, which provides benefits that are particularly useful in the air purge application over all alternatives

Aircraft are being provided with air purge systems for driving oxygen from the fuel tank. In particular, aircraft fuel tank air purge systems are designed to incorporate an air separation module that typically includes a number of tube-like elements. A compressed source of air drives compressed air through the tubes, and the tubes act to separate the air into nitrogen and oxygen. The nitrogen is utilized to purge any air, that might contain oxygen, from the fuel tank. It is not desirable to allow oxygen to be in the fuel tank.

The prior art systems preferably must operate over a wide range of airflow amounts. Moreover, it is desirable to have the highest pressure ratio achievable from a particular compressor. At times, the tubes within the air separation module may become somewhat clogged, thus providing resistance to increased flow. A compressor for providing the compressed air would preferably be capable of operating reliably across all of these operational ranges.

One item incorporated into compressors is a diffuser. The diffuser is mounted in the compressor outlet and serves to “recapture” pressure in the airflow from the compressor. Generally, a diffuser can be seen as converting energy from airflow velocity into increased pressure.

A vaned diffuser has been considered for fuel tank air purge systems. A vaned diffuser has a plurality of channels extending generally from an inner periphery of the diffuser radially outwardly to the outermost extent of the diffuser. The channels in a vaned diffuser are somewhat long. In particular, when the length of the channel is compared to the width of the channel, the ratios are much greater than one to one, and often on the order of ten to one, or even more. While such vaned diffusers have very good pressure ratio results over a very narrow band of flow volumes, they do not provide such benefits over a wider range of flow volumes. That is, the very narrow and long channels are tuned to a particular flow volume, and the diffuser provides greatly decreased benefit when operated outside of that range.

Another type of known diffuser considered for utilization in a fuel tank purge system is a vaneless diffuser. Essentially, a vaneless diffuser is a simple plate without any vanes or channels. While a vaneless diffuser provides generally constant operation over a wider range of flow volumes, it does not provide the pressure ratio increase of a vaned diffuser.

It would be desirable to achieve a compressor having a diffuser that provides a wide operational range, with an increased pressure ratio for utilization in fuel tank purge systems.

### SUMMARY OF THE INVENTION

In a disclosed embodiment of this invention, a compressor associated with a fuel tank air purge system is provided with a low solidity diffuser. Low solidity diffusers are known in the prior art but have never been incorporated into a fuel tank air purge system. A low solidity diffuser has very short chord length vanes. These short vanes are spaced by a relatively large “mouth” distance. Thus, the width of the channel compared to the length of the channel is much closer to a one to one ratio than with a vaned diffuser. In a disclosed embodiment, the width of the opening compared to the length of the vane is on the order of 0.63. In a low solidity diffuser, the vanes do not extend to the radially outward extent of the plate. In a disclosed embodiment, the overall diffuser plate had a radius of 4.0″, while the vane extended for only 3.0″, and was spaced from the outermost periphery by a distance of 1.0″.

The low solidity diffuser provides increased pressure ratio when compared to a vaneless diffuser. Moreover, it provides this increased pressure ratio over a greater range of flow volumes than that of the vaned diffuser.

These and other features of the present invention will be best understood from the following specification and drawings, the following of which is a brief description.

### BRIEF DESCRIPTION OF THE DRAWINGS

FIG. 1 is a schematic view of an airplane fuel tank air purge system.

FIG. 2 shows a compressor incorporated into the FIG. 1 system.

FIG. 3 compares the operational results of a low solidity diffuser to other diffusers.

FIG. 4 is a view of the diffuser plate incorporated into the inventive compressor of FIG. 2.

FIG. 5 is an enlarged view of a portion of FIG. 4.

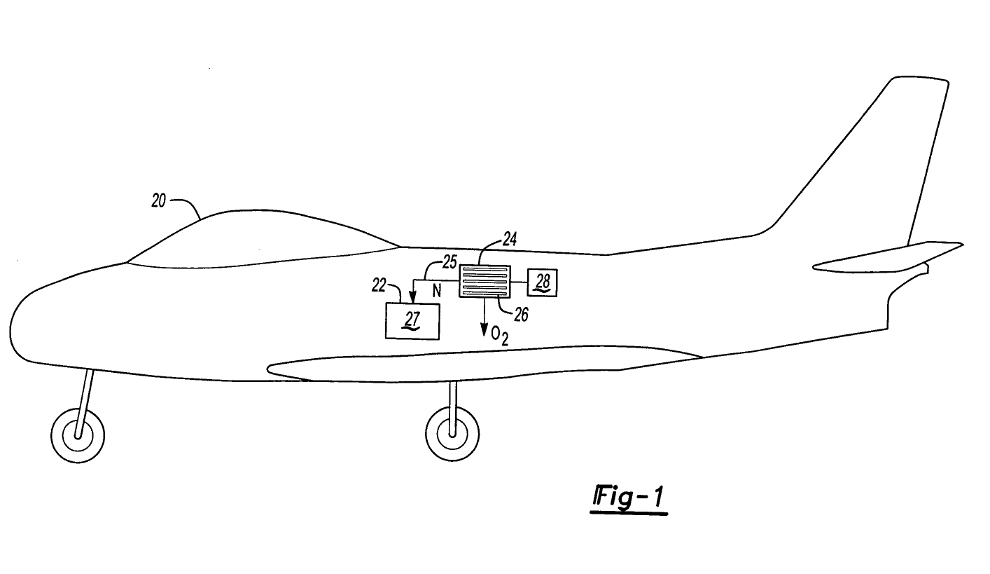

### DETAILED DESCRIPTION OF THE DRAWINGS

An aircraft 20 is provided with a fuel tank 22. An air separation module 24 provides a flow of nitrogen 25 into the fuel tank 22 to drive or purge air from the space 27 in the fuel tank 22. As is known, the air separation module includes elements, such as tube-like members 26 which serve to break a flow of compressed air into a nitrogen component delivered through line 25 to the fuel tank 22, and into a separated oxygen component which is directed away from the fuel tank.

The system incorporates a compressor 28 for providing the compressed airflow into the air separation module 24. The detail of the air separation module 24 and the air purge are generally as known in the art. It is the use of an inventive compressor/diffuser combination in this system to which this invention is directed.

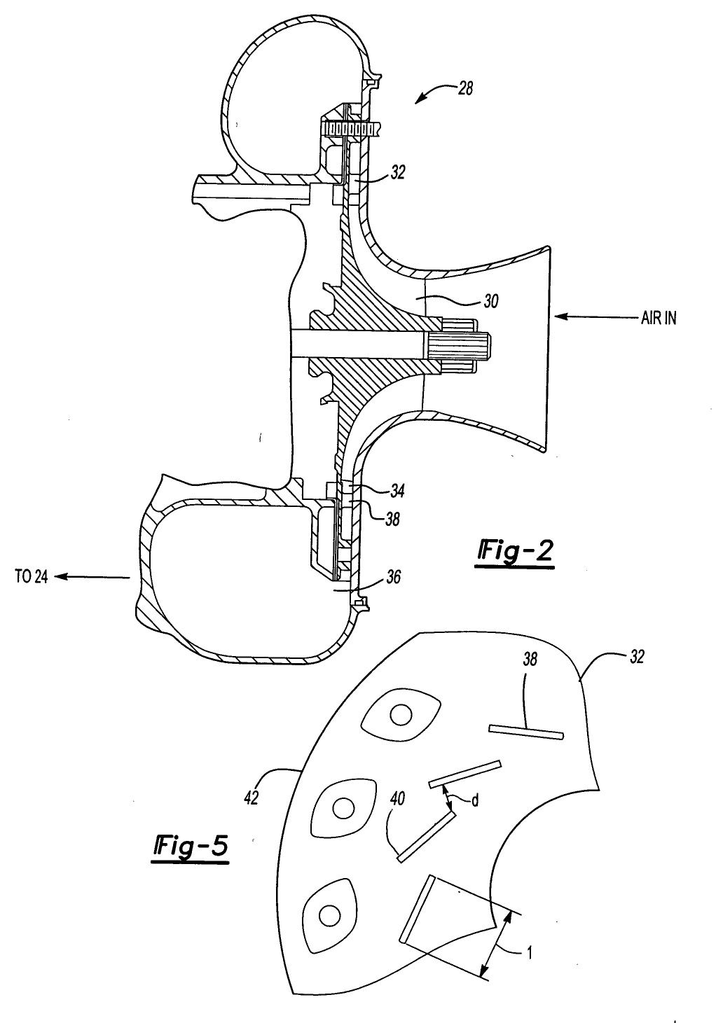

FIG. 2 shows the compressor 28 having a compressor rotor 30. Compressor rotor 30 is also associated with a low solidity diffuser 32. As shown, air reaches the outlet 34 of rotor 30, and is delivered along the relatively short vane 38 of the low solidity diffuser 32. Air then reaches an outlet 36 of the diffuser 32, and is directed to the air separation module 24.

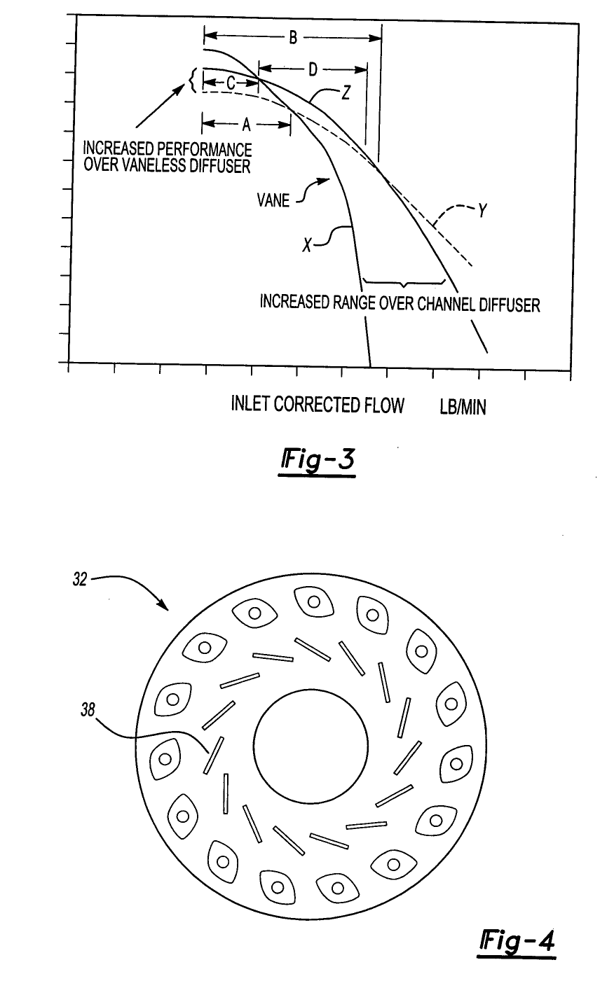

As shown in FIG. 3, the prior art vaned diffuser X has a relatively high pressure ratio over a relatively narrow band of flow volumes. Thus, as shown, the pressure ratio of a compressor utilizing a vaned diffuser is higher than the pressure ratio of a compressor utilizing a vaneless diffuser Y only a length A. Beyond this, the pressure ratio of the vaned diffuser drops sharply away from the pressure ratio provided by the vaneless diffuser. As shown also, a vaneless diffuser has relatively constant pressure ratios over a very great range of flow areas. However, there is not the pressure ratio benefit achieved with a vaned diffuser.

The present invention utilizes a low solidity diffuser. The low solidity diffuser Z has increased pressure ratio when compared to a vaneless diffuser over a range B. Moreover, while the vaned diffuser has an increased pressure ratio over a low solidity diffuser for a very small range C, the low solidity diffuser has a greater pressure ratio when compared to the vaned diffuser over its own relatively great range D.

The present invention thus provides increased pressure ratios when compared to a vaneless diffuser, but also ensures that increased pressure ratio over a wide range of operational flow volumes. As mentioned above, the flow volumes do vary during operation of the fuel tank air purge system.

FIG. 4 is a view of the low solidity diffuser 32. As shown (see FIG. 5), the vanes 38 have a length l and adjacent vanes are spaced by a mouth or throat area length d. As shown, an outermost point 40 of the vanes 38 is spaced from the outermost point 42 of the diffuser plate 32. In a preferred embodiment, the vane has a length of 0.80″, for a plate having a radius of 4.0″. As can be understood, the outermost end 40 of the vane 38 is thus spaced from the outermost point 42 by more than 50% of the radius of the plate 32. Further, the length l of the vane is on the order of 1.6 when compared to the distance d. Thus, the mouth area into the flow channels is much greater than if a vaned diffuser is utilized. The short vanes 38 do not have the narrow flow band resulting from the narrow mouth formed by the channels of a vaned diffuser.

Thus, the inventive compressor utilizing a low solidity diffuser in a fuel tank air purge system provides valuable benefits that are unique to the particular application.

Although a preferred embodiment of this invention has been disclosed, a worker in this art would recognize that certain modifications would come within the scope of this invention. For that reason, the following claims should be studied to determine the true scope and content of this invention.

What is claimed is:

1. An aircraft fuel tank purge system comprising:
an air separation module for receiving a flow of compressed air, and separating said flow of compressed air into a nitrogen and oxygen flow line; and
a compressor for delivering said flow of compressed air to said air separation module, said compressor being provided with a rotor, and a low solidity diffuser.

2. A system as set forth in claim 1, wherein said low solidity diffuser has a plurality of relatively short vanes at an inner periphery of a plate.

3. A system as set forth in claim 2, wherein a mouth distance is defined between circumferentially spaced ones of said plurality of vanes on said diffuser, said mouth distance being larger than that achieved by the utilization of a vaned diffuser.

4. A system as set forth in claim 2, wherein a distance between a radially outermost point on said vanes and a radially outermost point of said plate is greater than a length of said vanes.

5. An aircraft fuel system comprising:
a fuel tank for use on an aircraft;
an air purge system having an air separation module for receiving a flow of compressed air, and separating said flow of compressed air into a nitrogen and oxygen flow line; and
a compressor for delivering said flow of compressed air to said air separation module, said compressor being provided with a rotor, and a low solidity diffuser.

6. A system as set forth in claim 5, wherein said low solidity diffuser has a plurality of relatively short vanes at an inner periphery of a plate.

7. A system as set forth in claim 6, wherein a mouth distance is defined between circumferentially spaced ones of said plurality of vanes on said diffuser, said mouth distance being greater than that achieved by the utilization of a vaned diffuser.

8. A system as set forth in claim 6, wherein a distance between a radially outermost point on said vanes and a radially outermost point of said plate is greater than a length of said vanes.
